(19) United States
(12) Patent Application Publication
(10) Pub. No.: US 2006/0259495 A1
(43) Pub. Date: Nov. 16, 2006

(54) Batch transmitting server and batch transmitting method

(75) Inventor: Chia-Wei Huang, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/429,997

(22) Filed: May 9, 2006

(30) Foreign Application Priority Data
May 11, 2005 (TW) 094115302

(51) Int. Cl. G06F 17/30

(52) U.S. Cl. 707/10

(57) ABSTRACT

A batch transmitting server receives a client request of a client and comprises a database, a first selecting module, a temporary saving module, a second selecting module and a transmitting module. The first selecting module selects a plurality of requested data from the database according to the client request. The temporary saving module saves the requested data. The second selecting module selects a set of to-be-transmitted data from the temporary saving module according to a transmission setting. The transmitting module transmits the to-be-transmitted data to the client. Furthermore, a batch transmitting method applied with the batch transmitting server is provided.

### BACKGROUND OF THE INVENTION

1. Field of Invention

The invention relates to a data transmitting server and a data transmitting method. In particular, the invention relates to a batch transmitting server and a batch transmitting method.

2. Related Art

In the prior art, paging data are processed only after data are downloaded from the server completely. Therefore, all data have to be downloaded from the server before they are divided into pages.

As shown in FIG. 1, a user at a client 11 browses a web page 121 located on a server 12 by a web browser 111. The web page 121 provides an interface for the user to access a database 13. Therefore, the user can use the web browser 111 to browse the web page 121 in order to search (or create, delete, etc) a plurality of data 131 in the database 13.

After the user creates a very specific search on the web page 121, the database processing module 122 of the server 12 finds data 14 (e.g. 3000 items of data) from the database 13 corresponding to the specific search. The server transmits the data 14 (3000 items of data) to the client 11 at a time. Accordingly, the user can view the data 14 downloaded by the web browser 111 on the web page 121.

However, if all of the data 14 are transmitted to client 11, the processing of transmitting the data 14 is very time-consuming. Moreover, if the user only needs part of the content of the data 14, e.g. 20 items out of the 3000 items of the data 14, 2980 items of the data 14 are also transmitted to the client 11. Consequently, transmitting all of the data 14 (3000 items of the data 14) may waste the transmission bandwidth of the network and increase a complicated process for transmitting the undesired part of the data 14 (2980 items of the data 14). In other words, the client 11 has to download all of the data 14 (e.g. 3000 items of data) first, and then eliminates the undesired part (e.g. 2980 items of data), in order to render the 20 items of data that are in need. This step also consumes the efficiency of the client 11.

### SUMMARY OF THE INVENTION

In view of the foregoing, the invention is to provide a batch transmitting server and a batch transmitting method that can transmit data requested by a client from a server to the client.

To achieve the above, the batch transmitting server of the invention which receives a client request from a client includes a database, a first selecting module, a temporary saving module, a second selecting module, and a transmitting module. In the invention, the first selecting module selects a plurality of requested data from the database according to the client request. The temporary saving module saves the requested data. The second selecting module selects to-be-transmitted data from the temporary saving module according to a transmission setting. The transmitting module transmits the to-be-transmitted data to the client.

In addition, the invention also discloses a batch transmitting method, which includes the steps of: receiving a client request from a client by the server; selecting a plurality of requested data from a database according to the client request; saving the requested data in temporary memory of the server; selecting to-be-transmitted data from the temporary memory according to a transmission setting; and transmitting the to-be-transmitted data to the client.

As mentioned above, the batch transmitting server of the invention has a temporary saving module, a second selecting module and a transmitting module. Therefore, a huge amount of pre-selected data can be stored in the temporary saving module, and then the second selecting module can select to-be-transmitted data. The transmitting module then transmits the data to the client to achieve the goal of batching transmissions. Consequently, the invention can reduce the network burden and enhance the efficiency at the client.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional data transmitting server,

FIG. 2 is a block diagram showing a batch transmitting server according to a preferred embodiment of the invention;

FIG. 3 is a schematic view showing the data content stored in the database of the batching transmitting server in FIG. 2;

FIG. 4 is a schematic view showing the requested data content stored in the register module of the batch transmitting server in FIG. 2; and

FIG. 5 is a flowchart showing a batch transmitting method according to a preferred embodiment of the invention.

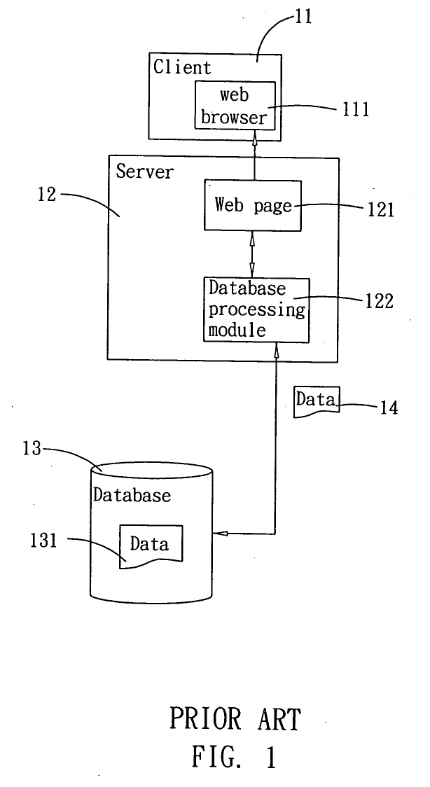

### DETAILED DESCRIPTION OF THE INVENTION

The present invention will be apparent from the following detailed description, which proceeds with reference to the accompanying drawings, wherein the same references relate to the same elements.

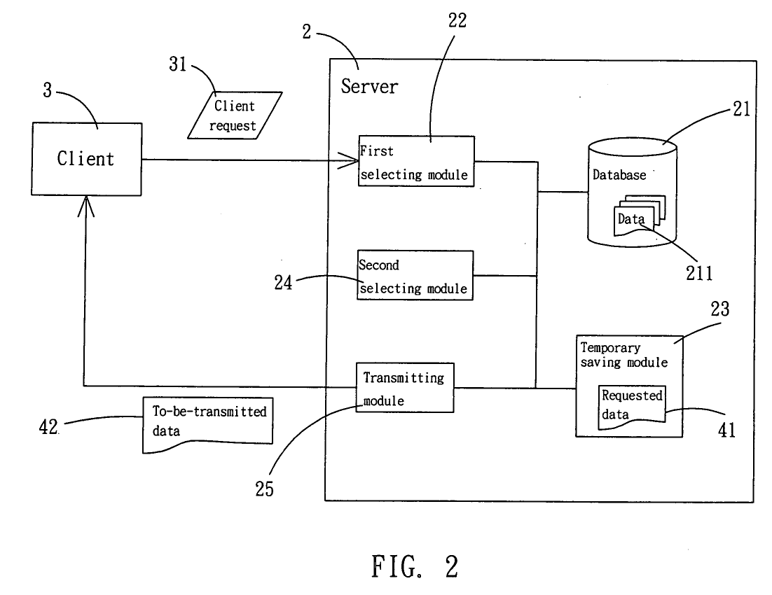

As shown in FIG. 2, a batch transmitting server 2 according to a preferred embodiment of the invention receives a client request 31 from a client 3. The server 2 includes a database 21, a first selecting module 22, a temporary saving module 23, a second selecting module 24, and a transmitting module 25.

The database 21 stores a plurality of data 211. The first selecting module 22 selects a plurality of requested data 41 from the data 211 according to the client request 31. The requested data 41 are stored in the temporary saving module 23. Afterwards, the second selecting module 24 selects to-be-transmitted data 42 from the temporary saving module 23 according to a transmission setting. The transmitting module 25 transmits the to-be-transmitted data 42 to the client 3.

In other words, the requested data 41 are first stored in the temporary saving module 23 for transmission in batches, instead of at a time. Besides, the database 2 can be a SQL database. The client request 31 includes a SQL database command to perform operations on the database 21.

The transmission setting assigns the range of the to-be-transmitted data 42. The second selecting module 24 selects the to-be-transmitted data 42 from the temporary saving module 23 according to the transmission setting. The transmitting module 25 transmits the to-be-transmitted data 42 to the client 3. Therefore, all of the data requested from the client request 31 are not sent to the client 3 at a time.

The transmission setting is determined by the client request 31 or by a default value of the server 2. For example, the client request 31 may be set such that the second selecting module 24 selects 30 items of the data each time. The default value of the server may be set such that the second selecting module 24 selects 20 items of the data each time, and the first to the 20^{th} sets of data are first selected for each selection.

The client 3 converts the format of the to-be-transmitted data 42 into a web page output format, so that the to-be-transmitted data 42 may be output to a web browser of the client 3 and displayed thereon.

For example, it is assumed that the database 2 is a human resource database, and the temporary saving module 23 is temporary memory of the server 2. The temporary memory may be a random access memory (RAM) or a storage medium in the server 2.

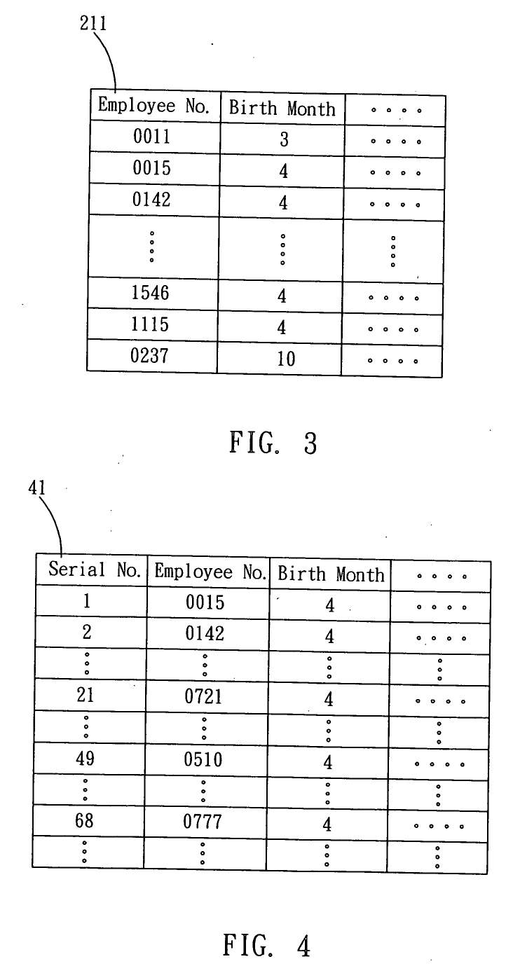

As shown in FIGS. 2, 3, and 4, the user sends a SQL command in the client request 31 to retrieve the human resource data of people born in April. The user may also send a command in the client request 31 to set the transmission setting as transmitting 20 items of data each time and that the 49^{th} to the 68^{th} items of data are transmitted first.

After the server 2 receives the client request 31, the first selecting module 22 selects the requested data 41 from the database 2 according to the SQL command and stores the requested data 41 in the temporary memory (the temporary saving module 23) of the server 2. The second selecting module 24 selects the 49^{th} to the 68^{th} items of data (the to-be-transmitted data 42) from the temporary memory of the server 2 according to the transmission setting. The 49^{th} to the 68^{th} items of data are then transmitted to the client 3.

If the user at the client 3 wants to retrieve the second to the 21^{st} items of data, he or she can send a command in the client request 31 to change the transmission setting for sending the second to the 21^{st} items of the data. The second selecting module 24 selects the second to the 21^{st} items of the data (the to-be-transmitted data 42) from the temporary memory of the server 2 according to the modified transmission setting. Moreover, the transmitting module 25 transmits the second to the 21^{st} items of the data to the client 3.

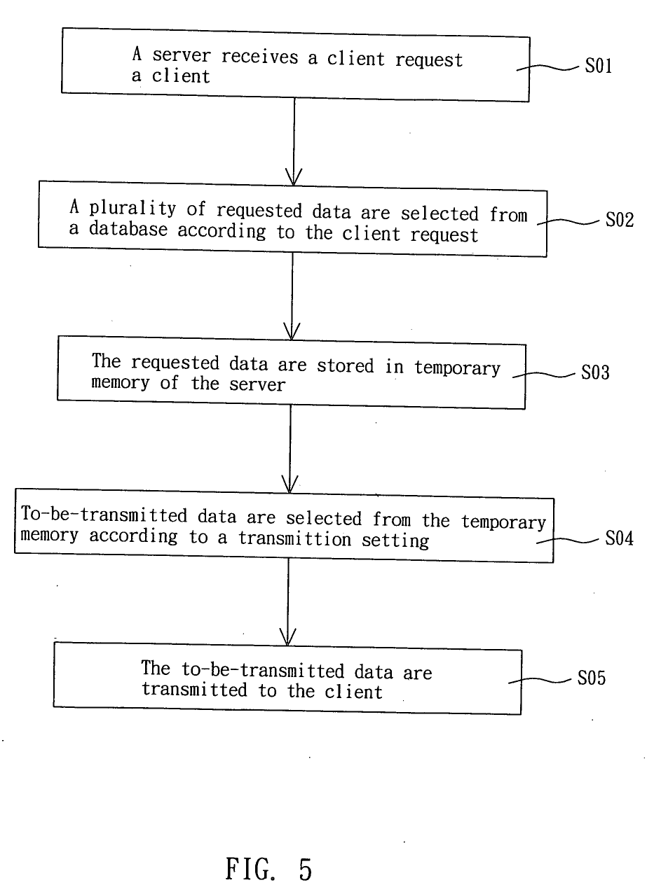

As shown in FIG. 5, the batch transmitting method according to a preferred embodiment of the invention includes steps S01 to S05.

In step S01, a server receives a client request from a client.

In step S02, a plurality of requested data are selected from a database according to the client request.

In step S03, the requested data are stored in temporary memory of the server.

In step S04, to-be-transmitted data are selected from the temporary memory according to a transmission setting.

In step S05, the to-be-transmitted data are transmitted to the client.

Since the batch transmitting method of the embodiment can be used on the batch transmitting server of the previously mentioned embodiment as disclosed in FIG. 2, the details are the same as the descriptions given above and are not repeated herein for concise purpose.

In summary, the batch transmitting server of the invention has a temporary saving module, a second selecting module and a transmitting module. Therefore, a huge amount of pre-selected data can be stored in the temporary saving module. After that, the second selecting module selects to-be-transmitted data. The transmitting module then transmits the data to the client to achieve the goal of batching transmissions. Moreover, compared with the prior art that data requested from user are transmitted to client and completely shown on the web page, the present invention provides a batch transmitting server that has a temporary memory for storing requested data temporarily and transmits the to-be-transmitted data according to a transmission setting. Consequently, the invention can reduce the network transmission burden and enhance the efficiency at the client.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A batch transmitting server receiving a client request from a client, comprising:
a database;
a first selecting module, which selects a plurality of requested data from the database according to the client request;
a temporary saving module, which stores the requested data;
a second selecting module, which selects at least one set of to-be-transmitted data from the temporary saving module according to a transmission setting; and
a transmitting module, which transmits the to-be-transmitted data to the client.

2. The server of claim 1, wherein the transmission setting assigns a range of the requested data.

3. The server of claim 1, wherein the transmission setting is determined according to the client request.

4. The server of claim 1, wherein the transmission setting is a default value of the server.

5. The server of claim 1, wherein the to-be-transmitted data are output to a web browser of the client.

6. The server of claim 1, wherein the client converts the format of the to-be-transmitted data to a web page output format.

7. A batch transmitting method, comprising:
receiving a client request from a client by a server;
selecting a plurality of requested data from a database according to the client request;
saving the requested data in a temporary memory of the server;
selecting at least one set of to-be-transmitted data from the temporary memory according to a transmission setting; and
transmitting the to-be-transmitted data to the client.

8. The method of claim 7, wherein the transmission setting assigns a range of the requested data.

9. The method of claim 7, wherein the transmission setting is determined according to the client request.

10. The method of claim 7, wherein the transmission setting is a default value of the server.

11. The method of claim 7, wherein the client request contains a SQL database command.

12. The method of claim 7, further comprising:
providing the to-be-transmitted data to a web browser of the client.

13. The method of claim 7, further comprising:
converting the format of the to-be-transmitted data to a web page output format.
